(19) United States
(12) Patent Application Publication
(10) Pub. No.: US 2014/0039704 A1
(43) Pub. Date: Feb. 6, 2014

(54) SYSTEM AND METHOD FOR PROTECTION OF GAS TURBINE HOT GAS PATH AND ROTOR PARTS FROM THERMAL DISTRESS

(71) Applicants: Valerie Suzanne VERNET, Inman, SC (US); Michael James FEDOR, Simpsonville, SC (US)

(72) Inventors: Valerie Suzanne VERNET, Inman, SC (US); Michael James FEDOR, Simpsonville, SC (US)

(73) Assignee: GENERAL ELECTRIC COMPANY, Schenectady, NY (US)

(21) Appl. No.: 13/565,354

(22) Filed: Aug. 2, 2012

(51) Int. Cl. G06F 1/26

(52) U.S. Cl. 700/287

(57) ABSTRACT

A system for operating a gas turbine includes a controller configured to: receive input from a plurality of sensors that sense parameters of the gas turbine during operation; run a first model of the operation of the gas turbine from one or more of the parameters; determine one or more unmeasured variables of the operation from the first model; run a second model of process variables from one or more of the sensed parameters and one or more of the unmeasured variables; determine differences between the process variables and associated boundaries; and adjust one or more effectors of the gas turbine to maintain a predetermined margin between the process variables and hardware physical limits.

The present invention relates generally to systems and methods for the protection of a gas turbine hot gas path and rotor parts from thermal distress.

### BACKGROUND OF THE INVENTION

Improved gas turbine performance may be achieved by running successively higher levels of turbine hot gas path inlet temperature. A common method of achieving increased turbine inlet gas temperature without deteriorating or otherwise distressing hot gas path parts involves applying cooling to turbine component parts. Turbine cooling flow may be bled from the gas turbine compressor and routed directly to the turbine or may be routed through a heat exchanger, or may be taken from an external source. The flow is routed through the secondary flow system to turbine blades and vanes, their platforms, seals, turbine disks, spacers, flanges and other turbine parts. Cooling flow that is routed through the gas turbine rotor may, under normal operation, be metered across seals and/or balanced across multiple seals in a design that ensures that all turbine parts are properly supplied with cooling to maintain metal temperatures within acceptable limits. Abnormal hardware events may result in damage to rotor seals which, in turn, may result in thermal distress of hot gas path parts.

One scenario which may disrupt flow is blockage of the flow paths by a foreign object. This may disrupt cooling flow, thus starving some parts and oversupplying others. With no intervention, this may cause increased metal temperature or inappropriate cooling distribution causing thermal damage, erosion, cracking, etc.

Traditionally, the secondary air flow region of the gas turbine has been monitored through the use of temperature instrumentation. Increased secondary air flow temperatures indicate insufficient cooling, thus a severe protective action may be taken by the turbine controller or the operator to prevent imminent and costly damage. The protective action may be an automatic shut-down or trip or a manual shut-down.

### BRIEF DESCRIPTION OF THE INVENTION

The invention is a model-based approach using the engine control effectors to maintain the gas turbine parts within acceptable limits and allow continued operation at a reduced level of performance. This is achieved by modeling the metal temperatures and supply pressures in substantially real time, and using a controller to adjust the effectors to maintain the desired margin.

According to one exemplary embodiment of the invention, a system for operating a gas turbine, comprises a controller configured to: receive input from a plurality of sensors that sense parameters of the gas turbine during operation; run a first model of the operation of the gas turbine from one or more of the sensed parameters; determine one or more unmeasured variables of the operation from the first model; run a second model of process variables from one or more of the sensed parameters and one or more of the unmeasured variables; determine differences between the process variables and associated boundaries; and adjust one or more effectors of the gas turbine to maintain a predetermined margin between the process variables and hardware physical limits.

According to another exemplary embodiment of the invention, a method of operating a gas turbine comprises receiving input from a plurality of sensors that sense parameters of the gas turbine during operation; running a first model of the operation of the gas turbine from one or more of the sensed parameters; determining one or more unmeasured variables of the operation from the first model; running a second model of process variables from one or more of the sensed parameters and one or more of the unmeasured variables; determining differences between the process variables and associated boundaries; and adjusting one or more effectors of the gas turbine to maintain a predetermined margin between the process variables and hardware physical limits.

### BRIEF DESCRIPTION OF THE DRAWINGS

FIG. 1 is a schematic diagram of a system to protect a gas turbine hot gas path and rotor parts from thermal distress.

### DETAILED DESCRIPTION OF THE INVENTION

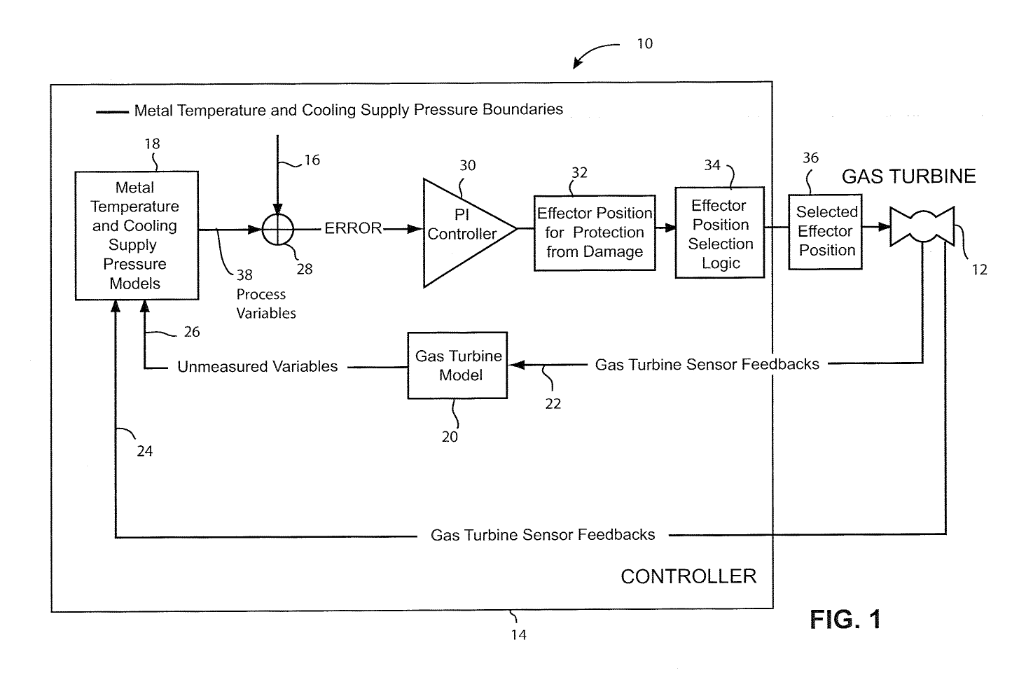

Referring to FIG. 1, a system 10 for protecting the hot gas path and rotor parts of a gas turbine 12 includes a controller or control system 14 configured to receive sensor inputs 22, 24 and create a substantially real-time model 18 of metal temperatures and cooling supply pressure. The control system 14 may also be configured to run a substantially real-time model 20 of the operation of the gas turbine 12, calculate unmeasured variables 26 regarding the operation of the gas turbine 12, and receive process variable boundaries 16. The boundaries may be calculated from sensors and unmeasured variables (they do not have to be constants). The control system 14 may be further configured to determine through an adder 28 the differences between the substantially real-time process variables and process variable boundaries 16, and provide the differences to a proportional-integral (PI) controller 30. The PI controller (or other suitable controllers including any combination of proportioned, integral or derivative controllers; or other controllers such as multi-variable or MIMO) 30 adjusts the position of an effector to control the process variables to a controlled set point, controls the rate at which the process variables approach the set point and controls overshoot of the set point. It should be appreciated that instead of the single PI controller 30, the effectors 36 may each include a PI controller (not shown).

As used herein, the term “process variables” will be understood to mean hot gas path metal temperatures, gas path and secondary flow path pressures and temperatures, as well as secondary flows and backflow margins. Similarly, the term “unmeasured variables” will be understood to include pressures and temperatures as well as component efficiencies, backflow margins, thrust and airflows.

In addition, it will be understood that that the term “substantially real time” contemplates implementations based on modeled variables that, for example, lead the part temperature(s). In other words, it may be more straightforward and substantially as accurate to control the variables that are faster such as gas path variables rather than certain slower, metal temperature variables that take time to develop.

The control system 14 may be, for example a computer configured to run software programs for performing the required calculations and creating the real time models. It should also be appreciated that the control system 14 may use existing circuits, known programming methods, structures and controllers well within the skill of the art.

The PI controller 30 may be configured to, for example, determine an effect or position 32 to protect the hot gas path and rotor parts of the gas turbine 12 from damage due to engine-to-engine variation, deterioration, mechanical faults, failures or damage to the engine or any of the engine components, etc. and mechanical faults, failures or damage relating to the control system 14 or its components. Effector position selection logic 34 may be provided to select an effector(s) that may be adjusted. The positions(s) 36 of the selected effector(s) is (are) adjusted to maintain the gas turbine parts within acceptable boundaries and allow continued operation at a reduced level of performance without exceeding hardware limits. The substantially real-time modeling of the operation of the gas turbine and the metal temperatures and cooling supply pressures allows the control system 14 to adjust the position of a selected effector to maintain a desired margin between the process variable(s) of the model(s) and the process variable boundaries.

The effectors may be, for example, actuators in the gas turbine that include fuel metering valves, inlet guide vanes, variable stator vanes, variable geometry, bleed valves, starter valves, clearance control valves, inlet bleed heat, and/or variable exhaust valves.

The hot gas path metal temperatures 22, 24, backflow margins, pressures, rotor speeds, actuator or effector positions, and/or flows or other process variables 38 representing the state of the turbine parts are modeled in substantially real time within the control system 14. The model 20 may be physics-based, neural net, or regression-based, or may use variable outputs from a physics-based model. A boundary is defined for each process variable. If a process variable increases and impinges on the boundary, changes to control effector positions 36 are applied.

The gas turbine model 20 may be a model of any physical system, control system, or property of the turbine or turbine subsystem, including but not limited to, the turbine itself, the gas path and gas path dynamics, actuators, effectors, or other controlling devices that modify or change any turbine behavior, sensors, monitors, or sensing systems, the fuel metering system, the fuel delivery system, the lubrication system and/or the hydraulic system. The model 20 may represent each of the main components of the gas turbine engine 12 at a system level, including for example the inlet, fan, compressor, combustor, high pressure turbine, low pressure turbine, afterburner, and variable area exhaust nozzle.

The invention has applications in both the power and aviation industries. In the commercial power industry the ability to continue operating with engine deterioration or damage is advantageous in giving the operator the opportunity to make an informed decision about when to shut down for repairs and, under certain circumstances, will permit the operator to continue selling power to customers. In the aviation industry, a high level of importance is placed on the ability to continue running gas turbines while the aircraft is in flight regardless of their condition. Every opportunity is provided in gas turbine operation to ensure the ability to land at the nearest airport in civilian applications, or to “get home” in military applications with all gas turbines running. Even in multi-engined aircraft, shut down of an engine can significantly impact aircraft flight characteristics. Continued operation with hot gas path part damage can lead to engine failure, and thus is a safety critical issue.

The invention methodology introduces flexibility into the control methodology, including the ability to maintain a higher turbine power level. The invention also facilitates reduction of power to the degree necessary to protect the gas turbine parts, thus reducing the impact on operation of the gas turbine. The invention may also prevent an unnecessary outage of the gas turbine and associated loss of revenue by allowing continued operation at a reduced output until the next scheduled maintenance period.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for operating a gas turbine, comprising:
a controller configured to:
receive input from a plurality of sensors that sense parameters of the gas turbine during operation;
run a first model of the operation of the gas turbine from one or more of the parameters;
determine one or more unmeasured variables of the operation from the first model;
run a second model of process variables from one or more of the sensed parameters and one or more of the unmeasured variables;
determine differences between the process variables and associated boundaries; and
adjust one or more effectors of the gas turbine to maintain a predetermined margin between the process variables and hardware physical limits.

2. A system according to claim 1, wherein the controller is configured to receive inputs from at least one of temperature sensors, pressure sensors, rotor speed sensors, effector position sensors, and flow sensors.

3. A system according to claim 1, wherein the unmeasured variables determined by the controller include one or more of pressures and temperatures, component efficiencies, backflow margins, thrust and airflows.

4. A system according to claim 1, wherein the unmeasured variables determined by the controller include one or more of thrust, backflow margins, component efficiencies, airflows, pressures and temperatures.

5. A system according to claim 1, wherein the one or more effectors includes a fuel metering valve, an inlet guide vane, a variable stator vane, a variable geometry, a bleed valve, a clearance control valve, an inlet bleed heat, a variable exhaust nozzle, a fuel delivery system, a lubrication system and/or a hydraulic system.

6. A system according to claim 1, wherein the first model and the second model are one of a physics-based, neural net, or regression-based model.

7. A system according to claim 6, wherein the first model and the second model are substantially real-time models.

8. A system according to claim 1, wherein the controller includes at least one controller configured to select the one or more effectors.

9. A system according to claim 8, wherein each sensor includes a proportional-integral controller.

10. A system according to claim 8, wherein the at least one proportional-integral controller controls a rate at which temperatures and cooling supply pressures approach temperature and cooling supply pressure limits.

11. A method of operating a gas turbine, comprising:
receiving input from a plurality of sensors that sense parameters of the gas turbine during operation;
running a first model of the operation of the gas turbine from one or more of the parameters;
determining one or more unmeasured variables of the operation from the first model;
running a second model of process variables from one or more of the sensed parameters and one or more of the unmeasured variables;
determining differences between the process variables and associated boundaries; and
adjusting one or more effectors of the gas turbine to maintain a predetermined margin between the process variables and hardware physical limits.

12. The method according to claim 11, wherein the inputs are received from at least one of temperature sensors, pressure sensors, rotor speed sensors, effector position sensors, and flow sensors.

13. The method according to claim 11, wherein the unmeasured variables determined by the controller include one or more of thrust, backflow margins, component efficiencies, airflows, pressures and temperatures.

14. The method according to claim 13, wherein the process variables include one or more of hot gas path metal temperatures, gas path and secondary flow path pressures and temperatures, secondary flows and backflow margins.

15. The method according to claim 11, wherein the one or more effectors includes a fuel metering valve, an inlet guide vane, a variable stator vane, a variable geometry, a bleed valve, a clearance control valve, an inlet bleed heat, a variable exhaust nozzle, a fuel delivery system, a lubrication system and/or a hydraulic system.

16. The method according to claim 11, wherein the first model and the second model are one of a physics-based, neural net, or regression based model.

17. The method according to claim 16, wherein the first model and the second model are substantially real time models.

18. The method according to claim 11, selecting the one or more effectors.

19. The method according to claim 11, further comprising controlling a rate at which the temperature and cooling supply pressure approaches the temperature and cooling supply pressure boundaries.

20. The method according to claim 14, wherein the first model and the second model are substantially real time models.
